(19) United States
(12) Patent Application Publication
(10) Pub. No.: US 2025/0097820 A1
(43) Pub. Date: Mar. 20, 2025

(54) DATA TRANSMISSION METHOD AND APPARATUS

(71) Applicant: HUAWEI TECHNOLOGIES CO., LTD., Shenzhen (CN)

(72) Inventors: Xiaohui PENG, Shenzhen (CN); Jiajin LUO, Shenzhen (CN); Yinggang DU, Shenzhen (CN); Min YAN, Shenzhen (CN); Baojian ZHOU, Shenzhen (CN); Xun YANG, Singapore (SG)

(73) Assignee: HUAWEI TECHNOLOGIES CO., LTD., Shenzhen, GD (CN)

(21) Appl. No.: 18/951,890

(22) Filed: Nov. 19, 2024

Related U.S. Application Data
(63) Continuation of application No. PCT/CN2023/089545, filed on Apr. 20, 2023.

(30) Foreign Application Priority Data
May 19, 2022 (CN) 202210556848.7

(51) Int. Cl. H04W 40/24; H04L 5/00; H04W 40/12

(52) U.S. Cl. CPC H04W 40/246; H04L 5/0048; H04W 40/12

(57) ABSTRACT

A data transmission method and apparatus, and relates to the communication field. In the method, after obtaining a path parameter of each of at least one communication path between a first device and a second device, the first device may demodulate first data based on a pilot and the path parameter of each communication path. In other words, when demodulating the first data, the first device may refer to not only the pilot but also the path parameter of each communication path. The path parameter of each communication path can assist in demodulating the first data. When the path parameter of each communication path assists in demodulating the first data, there may be no need for too many pilots. Therefore, a resource occupied by the pilot can be reduced.

### CROSS-REFERENCE TO RELATED APPLICATIONS

This application is a continuation of International Application No. PCT/CN2023/089545, filed on Apr. 20, 2023, which claims priority to Chinese Patent Application No. 202210556848.7, filed on May 19, 2022. The disclosures of the aforementioned applications are hereby incorporated by reference in their entireties.

### TECHNICAL FIELD

The embodiments relate to the communication field, and to a data transmission method and apparatus in the communication field.

### BACKGROUND

In an existing communication system, data is transmitted between two devices. One device needs to send a known reference signal to the other device, and the other device estimates a channel between the two devices based on the known reference signal, to obtain a channel estimation value. In this case, when one device sends data to the other device, the other device may demodulate the received data based on the channel estimation value. However, a known reference signal needs to occupy a large quantity of communication resources, leading to a small quantity of available resources for data transmission. This reduces spectral efficiency.

### SUMMARY

Embodiments provide a data transmission method and apparatus that can improve transmission spectral efficiency. According to a first aspect, a data transmission method is provided. The method is applicable to a first device and includes: obtaining a path parameter of each of at least one communication path between the first device and a second device; receiving a pilot and first data; and demodulating the first data based on the pilot and the path parameter of each communication path.

In the foregoing solution, after obtaining the path parameter of each of the at least one communication path between the first device and the second device, the first device may demodulate the first data based on the pilot and the path parameter of each communication path. In other words, when demodulating the first data, the first device may refer to not only the pilot but also the path parameter of each communication path. The path parameter of each communication path can assist in demodulating the first data. When the path parameter of each communication path assists in demodulating the first data, there may be no need for too many pilots. Therefore, a resource occupied by the pilot can be reduced, and available resources for data transmission can be increased, to improve spectral efficiency.

Optionally, the obtaining a path parameter of each of at least one communication path between the first device and a second device includes: receiving the path parameter of each of the at least one communication path between the first device and the second device from the second device; locally obtaining, by the first device, the path parameter of each of the at least one communication path between the first device and the second device; or receiving the path parameter of each of the at least one communication path between the first device and the second device from another device.

Optionally, the first device may be a network device, the second device may be a terminal device, and the first data may be data carried on a physical downlink shared channel (PDSCH).

Optionally, the first device may be a terminal device, the second device may be another terminal device, and the first data may be data carried on a sidelink shared channel (PSSCH).

Optionally, the pilot may be replaced with a reference signal.

Optionally, the path parameter of each communication path includes at least one of a delay of each communication path, an attenuation value of each communication path, an azimuth of departure AOD of each communication path, a zenith of departure ZOD of each communication path, an azimuth of arrival AOA of each communication path, or a zenith of arrival ZOA of each communication path.

In some possible implementations, the demodulating the first data based on the pilot and the path parameter of each communication path includes:
obtaining a first channel estimation value by measuring the pilot;
calibrating the path parameter of each communication path based on the first channel estimation value, to obtain a calibrated path parameter of each communication path; and
demodulating the first data based on the calibrated path parameter of each communication path.

In the foregoing solution, the terminal device may calibrate the path parameter of each communication path based on the first channel estimation value obtained by using the pilot, and demodulate the first data by using the calibrated path parameter of each communication path. The pilot is known to the terminal device and the network device. Therefore, after the path parameter of each communication path is calibrated by using the first channel estimation value obtained by using the known pilot, the calibrated path parameter of each communication path is relatively accurate. Therefore, accuracy of demodulating the first data can be improved, and a problem of inaccurate demodulation of the first data caused when the uncalibrated path parameter of each communication path is used to demodulate the first data is avoided. In addition, the first device can calibrate the path parameter of each communication path based on the first channel estimation value obtained by using the pilot. Even if there are a small quantity of pilots, the path parameter of each communication path can be calibrated, and the calibrated path parameter of each communication path is used to demodulate the first data. Therefore, resource overheads caused because a large quantity of pilots are required to demodulate the first data are avoided.

In some possible implementations, the at least one communication path is K communication paths, and the calibrating the path parameter of each communication path based on the first channel estimation value, to obtain a calibrated path parameter of each communication path includes:
determining, under a constraint that differences between path parameters of the K communication paths and calibrated path parameters of the K communication paths are less than a preset value, the calibrated path parameters of the K communication paths, so that the calibrated path parameters of the K communication paths minimize a difference between a second channel estimation value for the pilot and the first channel estimation value.

In the foregoing solution, the terminal device may perform channel estimation on the pilot by using the calibrated path parameters of the K communication paths, to obtain the second channel estimation value; and the terminal device may measure the pilot to obtain the first channel estimation value. The terminal device may search for, under the constraint that the differences between the uncalibrated path parameters of the K communication paths and the calibrated path parameters of the K communication paths are less than the preset value, the calibrated path parameters of the K communication paths, to minimize the difference between the first channel estimation value and the second channel estimation value. In this way, the obtained calibrated path parameters of the K communication paths are more accurate, so that accuracy of demodulating the first data can be improved.

In some possible implementations, the path parameters of the K pieces of communication include an amplitude and a delay, and the determining, under a constraint that differences between path parameters of the K communication paths and calibrated path parameters of the K communication paths are less than a preset value, the calibrated path parameters of the K communication paths, so that the calibrated path parameters of the K communication paths minimize a difference between a second channel estimation value for the pilot and the first channel estimation value includes:
determining the calibrated path parameters of the K communication paths according to formula (1) and formula (2):

$${arg min}_{( {A}_{k} , {τ}_{k} )} {‖ [ {\sum }_{k = 1}^{K} {A}_{k} exp ( - j 2 π {f}_{pilot} {τ}_{k} ) ] - H ( {f}_{pilot} ) ‖}^{2} , and \qquad ( 1 )$$

$$s . t . {‖ A - \hat{A} ‖}^{2} < {ε}_{1} {‖ τ - \hat{τ} ‖}^{2} < {ε}_{2} , \qquad ( 2 )$$

where

H(fₚᵢₗₒₜ) in formula (1) is the first channel estimation value,

$${\sum }_{k = 1}^{K} {A}_{k} exp ( - j 2 π {f}_{pilot} {τ}_{k} )$$

in formula (1) is the second channel estimation value,

$${arg min}_{( {A}_{k} , {τ}_{k} )} ( \cdot )$$

is a value for Aₖ and τₖ that enables

$${‖ [ {\sum }_{k = 1}^{K} {A}_{k} exp ( - j 2 π {f}_{pilot} {τ}_{k} ) ] - H ( {f}_{pilot} ) ‖}^{2}$$

to reach a minimum value, A in formula (2)=[A₁, A₂, . . . , A_{K}], Aₖ in formula (1) is a value in A₁, A₂, . . . , A_{K}, A is a vector consisting of calibrated amplitudes of the K communication paths, Â=[Â₁, Â₂, . . . , Â_{K}] and is a vector consisting of amplitudes of the K communication paths, τ=[τ₁, τ₂, . . . , τ_{K}], τₖ in formula (1) is a value in τ₁, τ₂, . . . , τ_{K}, τ is a vector consisting of calibrated delays of the K communication paths, \hat{τ}=[\hat{τ}₁, \hat{τ}₂, . . . , \hat{τ}_{K}] and is a vector consisting of delays of the K communication paths, ε₁ is a preset value corresponding to the amplitude, and ε₂ is a preset value corresponding to the delay.

In some possible implementations, before the obtaining a path parameter of each of at least one communication path between the first device and a second device, the method further includes:

sending location information of the first device to the second device, where the path parameter of each of the at least one communication path corresponds to the location information of the first device.

In the foregoing solution, after the first device sends the location information of the first device to the second device, the second device may determine the path parameter of each of the at least one communication path based on the location information of the first device.

Optionally, the obtaining a path parameter of each of at least one communication path between the first device and a second device includes: receiving, from the second device, the path parameter of each of the at least one communication path that is between the first device and the second device and that corresponds to the first location information.

Optionally, the first location information indicates a location of the first device.

In some possible implementations, a ratio of a resource occupied by the pilot to a total resource is less than or equal to a first preset value, and the total resource is a sum of the resource occupied by the pilot and a resource occupied by the first data.

In some possible implementations, the first preset value is 0.0238 or 0.0476.

In the foregoing method, when the ratio of the resource occupied by the pilot to the total resource is less than or equal to 0.0238 or 0.0476, the pilot occupies a small quantity of resources, and the first data occupies a large quantity of resources. Therefore, spectral efficiency of transmitting the first data can be improved.

In some possible implementations, the method further includes: receiving first configuration information, where the first configuration information indicates a frequency domain resource of the pilot. The receiving a pilot includes: receiving the pilot based on the first configuration information.

In some possible implementations, the method further includes: receiving a first signal, and obtaining feedback information corresponding to the first signal; and sending the feedback information corresponding to the first signal, where the feedback information corresponding to the first signal is used to determine the first configuration information, and the first configuration information indicates a subcarrier spacing of the pilot.

Optionally, the feedback information corresponding to the first signal indicates signal quality of the received first signal.

Optionally, the feedback information corresponding to the first signal may indicate an SNR of the first signal, and the SNR of the first signal is positively correlated with the subcarrier spacing that is of the pilot and that is indicated by the first configuration information.

In the foregoing solution, the first device may determine, based on the SNR of the first signal, the subcarrier spacing that is of the pilot and that is indicated by the first configuration information. A higher SNR of the first signal indicates a larger subcarrier spacing that is of the pilot and that is indicated by the first configuration information, and a lower SNR of the first signal indicates a smaller subcarrier spacing that is of the pilot and that is indicated by the first configuration information. In other words, a larger SNR indicates better channel quality, and channel estimation can be performed by using a small quantity of pilots. Therefore, the subcarrier spacing of the pilot may be large. In this way, a resource occupied by the pilot can be reduced, and a resource occupied for data transmission can be increased, to improve spectral efficiency. A smaller SNR indicates poorer channel quality, and channel estimation can be performed by using more pilots. Therefore, the subcarrier spacing of the pilot may be small.

In some possible implementations, a precision requirement for demodulating the first data is used to determine the first configuration information.

Optionally, a higher precision requirement for demodulating the first data indicates a smaller subcarrier spacing, and a lower precision requirement for demodulating the first data indicates a larger subcarrier spacing. In other words, if precision of demodulating the first data is higher, a required channel estimation value is more accurate. Therefore, a large quantity of pilots are required to obtain an accurate channel estimation value. In this case, the subcarrier spacing of the pilot is small. If precision of demodulating the first data is lower, the channel estimation value may be inaccurate. Therefore, a less accurate channel estimation value may also be obtained by using a small quantity of pilots. In this case, the subcarrier spacing of the pilot may be large.

According to a second aspect, a data transmission method is provided. The method is applicable to a second device and includes: determining a path parameter of each of at least one communication path between a first device and the second device; sending the path parameter of each of the at least one communication path; and sending a pilot and first data, where the pilot and the path parameter of each communication path are used to demodulate the first data.

In the foregoing solution, after determining the path parameter of each of the at least one communication path between the first device and the second device, the second device sends the path parameter of each communication path to the first device, and the second device may send the first data and the pilot. The first device may demodulate the first data based on the pilot and the path parameter of each communication path. In other words, when demodulating the first data, the first device may refer to not only the pilot but also the path parameter of each communication path. The path parameter of each communication path can assist in demodulating the first data. When the path parameter of each communication path assists in demodulating the first data, there may be no need for too many pilots. Therefore, a resource occupied by the pilot can be reduced, and available resources for data transmission can be increased, to improve spectral efficiency.

In some possible implementations, the determining a path parameter of each of at least one communication path between a first device and the second device includes:
receiving location information of the first device; and
determining the path parameter of each of the at least one communication path based on the location information of the first device and a map.

In some possible implementations, a ratio of a resource occupied by the pilot to a total resource is less than or equal to a first preset value, and the total resource is a sum of the resource occupied by the pilot and a resource occupied by the first data.

In some possible implementations, the first preset value is 0.0238 or 0.0476.

In some possible implementations, the method further includes: sending first configuration information, where the first configuration information indicates a frequency domain resource of the pilot. The sending a pilot includes: sending the pilot based on the first configuration information.

In some possible implementations, the method further includes: sending a first signal; receiving feedback information corresponding to the first signal; and determining the first configuration information based on the feedback information corresponding to the first signal, where the first configuration information indicates a subcarrier spacing of the pilot.

In some possible implementations, the first configuration information is further determined based on a precision requirement for demodulating the first data.

For other descriptions of the second aspect, refer to the descriptions of the first aspect.

According to a third aspect, the embodiments provide a communication apparatus. The communication apparatus has a function of implementing behavior of each device in each of the foregoing aspects and the possible implementations of the foregoing aspects. The function may be implemented by hardware, or may be implemented by hardware by executing corresponding software. The hardware or the software includes one or more modules or units corresponding to the foregoing function, for example, a processing module or unit, or a transceiver module or unit.

Optionally, the communication apparatus may be a chip.

Optionally, the communication apparatus may be the first device in the first aspect. Optionally, the communication apparatus may be the second device in the second aspect.

According to a fourth aspect, the embodiments provide a communication apparatus. The communication apparatus includes a processor. The processor is coupled to a memory. The memory is configured to store a computer program or instructions. The processor is configured to execute the computer program or the instructions stored in the memory, to enable the method in each of the foregoing aspects and the possible implementations of the foregoing aspects to be performed.

For example, the processor is configured to execute the computer program or the instructions stored in the memory, to enable the communication apparatus to perform the method in each of the foregoing aspects and the possible implementations of the foregoing aspects.

Optionally, the communication apparatus includes one or more processors.

Optionally, the communication apparatus may further include the memory coupled to the processor.

Optionally, the communication apparatus may include one or more memories.

Optionally, the memory and the processor may be integrated together or disposed separately.

Optionally, the communication apparatus may further include a transceiver.

Optionally, the communication apparatus may be the first device in the first aspect. Optionally, the communication apparatus may be the second device in the second aspect.

According to a fifth aspect, the embodiments provide a non-transitory computer-readable storage medium, including computer instructions. When the computer instructions are run on a device, the device is enabled to perform the foregoing aspects or any one of the possible methods of the foregoing aspects, or the method described in any one of embodiments.

According to a sixth aspect, the embodiments provide a computer program product. When the computer program product runs on a device, the device is enabled to perform the foregoing aspects or any one of the possible methods of the foregoing aspects, or the method described in any one of embodiments.

### BRIEF DESCRIPTION OF DRAWINGS

FIG. 1 is a diagram of an application scenario according to an embodiment;

FIG. 2 is a diagram of a data transmission method according to an embodiment;

FIG. 3 is a diagram of a communication path in a downlink transmission scenario according to an embodiment;

FIG. 4 is a diagram of a communication path in another downlink transmission scenario according to an embodiment;

FIG. 5 is a diagram of a ZOD and an AOD according to an embodiment;

FIG. 6 is a diagram of a ZOA and an AOA according to an embodiment;

FIG. 7 is a diagram of a communication path in a downlink transmission scenario in a multi-antenna scenario according to an embodiment;

FIG. 8 is a diagram of another data transmission method according to an embodiment;

FIG. 9 is a diagram of a communication path in an uplink transmission scenario according to an embodiment;

FIG. 10 is a diagram of another data transmission method according to an embodiment; and

FIG. 11 is a diagram of a data transmission apparatus according to an embodiment.

### DETAILED DESCRIPTION OF EMBODIMENTS

The following describes the solutions in embodiments with reference to the accompanying drawings.

The solutions in embodiments may be applied to various communication systems, for example, a global system for mobile communications ( ), a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, a 5th generation (5G) system, a new radio (NR) system, or another future communication system.

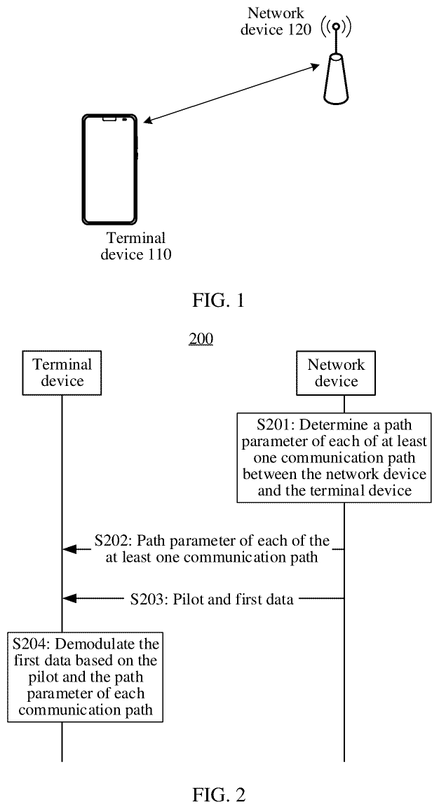

FIG. 1 is a diagram of an application scenario to which an embodiment is applied. As shown in FIG. 1, a system includes a terminal device 110 and a network device 120.

The terminal device 110 is also referred to as user equipment (UE), a mobile station (MS), a mobile terminal (MT), an access terminal, a subscriber unit, a subscriber station, a mobile station, a remote station, a remote terminal, a mobile device, a user terminal, a terminal, a wireless communication device, a user agent, a user communication apparatus, or the like.

The terminal device 110 may be a device, for example, a hand-held device or a vehicle-mounted device having a wireless connection function, that provides voice/data connectivity for a user. Currently, some examples of the terminal device include: a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop ( ) station, a personal digital assistant (PDA), a handheld device having a wireless communication function, a computing device or another processing device connected to a wireless modem, a vehicle-mounted device, a wearable device, an uncrewed aerial vehicle, a terminal device in a 5G network, or a terminal device in a future evolved public land mobile communication network (PLMN). This is not limited.

The network device 120 may also be referred to as a radio access network (RAN) or a radio access network device. The network device 120 may be a transmission reception point (TRP), an evolved NodeB (eNB, or eNodeB) in an LTE system, a home NodeB (for example, a home evolved NodeB or a home NodeB, HNB), a baseband unit (BBU), or a radio controller in a cloud radio access network (CRAN) scenario. Alternatively, the network device 120 may be a relay station, an access point, a vehicle-mounted device, a wearable device, an uncrewed aerial vehicle, a satellite, a network device in a 5G network, a network device in a future evolved PLMN network, or the like. Alternatively, the network device 120 may be an access point (access point, AP) in a wireless local area network (WLAN) or a gNB in an NR system. Alternatively, the network device 120 may be a city base station, a micro base station, a pico base station, a femto base station, or the like. This is not limited.

In a network structure, the network device 120 may include a central unit (CU) node, a distributed unit (distributed unit, DU) node, a radio access network (RAN) device including a CU node and a DU node, or a device including a control plane CU node (a CU-CP node), a user plane CU node (CU-UP node), and a DU node.

It should be understood that FIG. 1 shows the terminal device 110 and the network device 120 as examples merely for ease of understanding, but this should not constitute any limitation on the embodiments. The wireless communication system may further include more network devices, or may include more or fewer terminal devices. This is not limited. The terminal device 110 may be at a fixed location, or may be movable.

Optionally, the network device 120 in FIG. 1 may be replaced with a terminal device. A link for data transmission between terminal devices is referred to as a sidelink. The sidelink can be used in a scenario in which direct communication such as vehicle-to-another-device (V2X) or device-to-device (D2D) can be performed between devices. V2X communication may be considered as a special case of D2D communication. Optionally, a new radio (NR) access technology is a current mainstream wireless communication technology. For a V2X service feature and a new service requirement, the new radio access technology can support V2X communication having a lower delay and higher reliability. V2X is a basic and key technology for implementing an intelligent vehicle, autonomous driving, and an intelligent transportation system. V2X may include vehicle-to-network (V2N), vehicle-to-vehicle (V2V), vehicle-to-infrastructure (V2I), vehicle-to-pedestrian (V2P), and the like.

For ease of description, a device number is omitted below. For example, the “terminal device 110” may be simplified as a “terminal device”, and the “network device 120” may be simplified as a “network device”.

In an existing communication system, data is transmitted between two devices. One device needs to send a known reference signal to the other device, and the other device estimates a channel between the two devices based on the known reference signal, to obtain a channel estimation value. In this case, when one device sends data to the other device, the other device may demodulate the received data based on the channel estimation value. However, a known reference signal needs to occupy a large quantity of communication resources, leading to a small quantity of available resources for data transmission. This reduces spectral efficiency. For example, in the scenario shown in FIG. 1, before the network device and the terminal device transmit data, the network device may send a known reference signal, the terminal device measures the known reference signal to obtain a channel estimation value, the network device may send data to the terminal device, and the terminal device demodulates the received data based on the channel estimation value. The reference signal sent by the network device needs to occupy a large quantity of communication resources. Consequently, available resources for sending data by the network device to the terminal device are reduced. This reduces spectral efficiency of sending the data by the network device.

In embodiments, after obtaining a path parameter of each of at least one communication path between a first device and a second device, the first device may demodulate first data based on a pilot and the path parameter of each communication path. In other words, when demodulating the first data, the first device may refer to not only the pilot but also the path parameter of each communication path. The path parameter of each communication path can assist in demodulating the first data. When the path parameter of each communication path assists in demodulating the first data, there may be no need for too many pilots. Therefore, a resource occupied by the pilot can be reduced, and available resources for data transmission can be increased, to improve spectral efficiency.

The following describes a data transmission method 200 in an embodiment with reference to FIG. 2. In the method 200, a first device may be a terminal device, and a second device may be a network device. As shown in FIG. 2, the method 200 includes the following steps.

S201: The network device determines a path parameter of each of at least one communication path between the network device and the terminal device.

Optionally, there may be one or more communication paths between the network device and the terminal device, and the one or more communication paths may include the at least one communication path in S201. For example, there are three communication paths between the network device and the terminal device, and the at least one communication path in S201 may be two or one of the three communication paths.

Optionally, before S201, the method further includes: the network device determines a parameter of a communication path corresponding to each place on a map.

Optionally, S201 includes: the network device receives first location information that is of the terminal device and that is sent by the terminal device, where the first location information indicates a location of the terminal device; and the network device determines the path parameter of each of the at least one communication path based on the first location information of the terminal device and the map. In other words, the network device stores the parameter of the communication path corresponding to each place on the map. If the location that is of the terminal device and that is indicated by the first location information is a place on the map, the network device determines a parameter of a communication path corresponding to the place as the at least one communication path between the network device and the terminal device.

Optionally, before the network device determines the path parameter of each of the at least one communication path based on the first location information of the terminal device and the map, the method further includes: the network device determines the path parameter of the communication path corresponding to each place on the map. The path parameter of the communication path corresponding to each place on the map is a path parameter of a communication path corresponding to the network device and each place. For example, a place A and a place B exist on the map, the network device determines a path parameter of a communication path between the network device and the place A, and the network device determines a path parameter of a communication path between the network device and the place B. Optionally, quantities of communication paths between the network device and different places may be the same or different. For example, a quantity of communication paths between the network device and the place A is M, a quantity of communication paths between the network device and the place B may be N, M and N are positive integers greater than or equal to 1, and M and N may be the same or different.

Optionally, that the network device determines the path parameter of the communication path corresponding to each place on the map includes: the network device determines, based on four-dimension (dimension, D) environment information, a location of the network device, and a location of each place, the path parameter of the communication path corresponding to the network device and each place. Optionally, the 4D environment information includes 3D environment geometric information and 1D electromagnetic information between the network device and each place, and the 1D electromagnetic information is electromagnetic information of a reflector between the network device and each place. For example, the network device needs to determine a path parameter of a communication path corresponding to a place A on the map and a path parameter corresponding to a place B. The network device determines, based on 3D environment geometric information between the network device and the place A, 1D electromagnetic information of a reflector between the network device and the place A, the location of the network device, and a location of the place A, the path parameter of the communication path between the network device and the place A, which is also referred to as the path parameter of the communication path corresponding to the network device and the place A. The network device determines, based on 3D environment geometric information between the network device and the place B, 1D electromagnetic information of a reflector between the network device and the place B, the location of the network device, and a location of the place B, the path parameter of the communication path between the network device and the place B, which is also referred to as the path parameter of the communication path corresponding to the network device and the place B. The 1D electromagnetic information may include at least one of roughness, dielectric constants corresponding to the reflector at different frequencies, or magnetic permeabilities corresponding to the reflector at different frequencies.

Optionally, the 3D environment geometric information includes information related to a building, a road, and a tree environment between the network device and the place.

Optionally, that the network device determines, based on the 4D environment information, the location of the network device, and the location of each place, the path parameter of the communication path corresponding to the network device and each place may include: The network device may determine, by using a full-wave electromagnetic calculation method or a ray tracing method, the 4D environment information, the location of the network device, and the location of each place, the path parameter of the communication path corresponding to the network device and each place. The full-wave electromagnetic calculation method has high precision but high calculation complexity. The ray tracing method has lower precision than the full-wave electromagnetic calculation method, and has high calculation complexity.

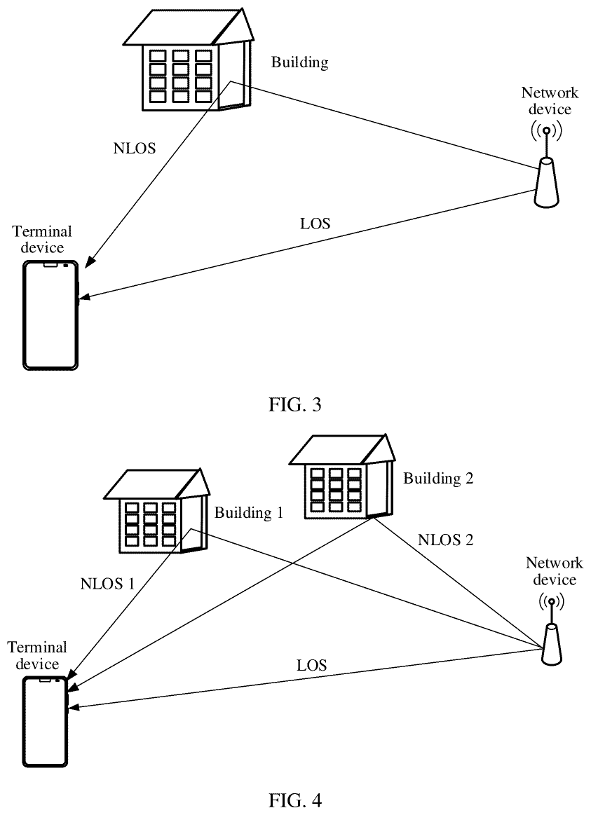

Optionally, one or more communication paths between the network device and the terminal device may be non-line of sights (NLOSs). For example, as shown in FIG. 3, in a downlink transmission scenario, the network device may be a party that sends data, and the terminal device may be a party that receives data. There may be one line of sight (LOS) and one NLOS between the network device and the terminal device. For another example, as shown in FIG. 4, in a downlink transmission scenario, the network device may be a party that sends data, and the terminal device is a party that receives data. There may be one LOS and two NLOSs between the network device and the terminal device, and the two NLOSs are an NLOS 1 and an NLOS 2.

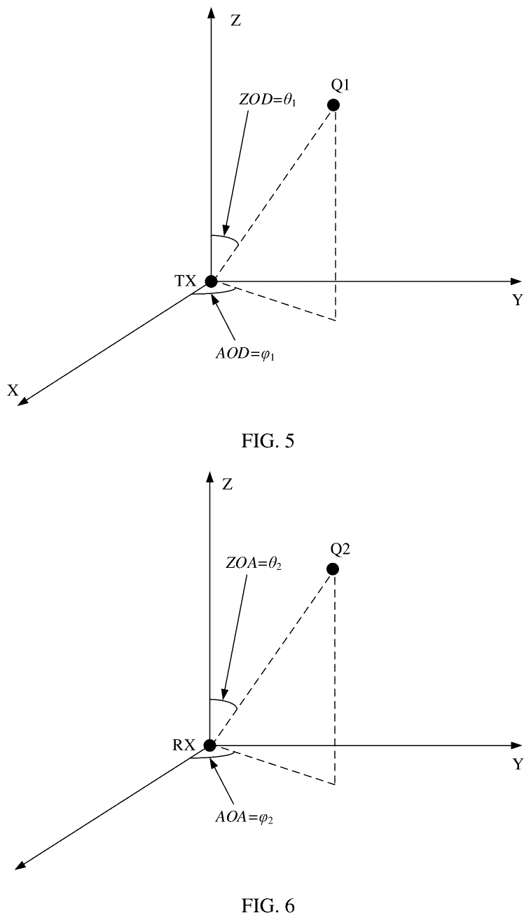

Optionally, the path parameter of the communication path may include at least one of an amplitude, a delay, a zenith of departure (ZOD), an azimuth of departure (AOD), a zenith of arrival (ZOA), or an azimuth of arrival (AOA). The ZOD is an angle, in a Z-axis direction, of a vector formed by a connection line between a signal sending device and a first reflection point, a projection vector, on an X-Y plane, of the vector formed by the connection line between the signal sending device and the first reflection point is a first projection vector, and the AOD is an angle of the first projection vector in an X-axis direction, where the first reflection point is a reflection point closest to the signal sending device. The ZOA is an angle, in the Z-axis direction, of a vector formed by a connection line between a signal receiving device and a second reflection point, a projection vector, on the X-Y plane, of the vector formed by the connection line between the signal receiving device and the second reflection point is a second projection vector, and the AOA is an angle of the second projection vector in the X-axis direction, where the second reflection point is a reflection point closest to the signal receiving device. If there are a plurality of reflection points between the signal sending device and the signal receiving device, the first reflection point is different from the second reflection point. If there is one reflection point between the signal sending device and the signal receiving device, the first reflection point is the same as the second reflection point. For example, as shown in FIG. 5, TX is the signal sending device, and is also referred to as a transmit end, and Q1 is the first reflection point. For example, in the scenario shown in FIG. 3, TX is the network device in FIG. 3, and the first reflection point Q1 is a building in FIG. 3. For example, in the scenario shown in FIG. 4, TX is the network device in FIG. 4. If the communication path is the NLOS 1, the first reflection point is a building 1 in FIG. 4. If the communication path is the NLOS 2, the first reflection point is a building 2 in FIG. 4. As shown in FIG. 5, ZOD=θ₁, and AOD=φ₁. For another example, as shown in FIG. 6, RX is the signal receiving device, and is also referred to as a receive end, and Q2 is the second reflection point. In the scenario shown in FIG. 3, RX is the terminal device in FIG. 3, and the second reflection point Q2 is a building in FIG. 3. In the scenario shown in FIG. 4, RX is the terminal device in FIG. 4. If the communication path is the NLOS 1, the second reflection point is a building 1 in FIG. 4. If the communication path is the NLOS 2, the second reflection point is a building 2 in FIG. 4. As shown in FIG. 6, ZOA=θ₂, and AOA=φ₂.

S202: The network device sends the path parameter of each of the at least one communication path to the terminal device, and the terminal device receives the path parameter of each of the at least one communication path from the network device.

Optionally, before S202, the network device sends a trigger signal to the terminal device, and the trigger signal is used to trigger the terminal device to enable a sensing-assisted communication function. The sensing-assisted communication function may be that the terminal device needs to calibrate a received path parameter of each of the at least one communication path, and demodulate first data by using the calibrated path parameter of each communication path. In other words, the trigger signal may trigger the terminal device to perform the method in this embodiment.

Optionally, the network device may send downlink control information (, DCI) or radio resource control (RRC) signaling to the terminal device, and the DCI or the RRC signaling includes the trigger signal.

S203: The network device sends the pilot and the first data to the terminal device, and the terminal device receives the pilot and the first data from the network device.

Optionally, in S203, a sequence in which the network device sends the pilot and the first data is not limited.

Optionally, time domain resources occupied for the network device to send the pilot and the first data to the terminal device are time domain resources in a same slot or time domain resources in different slots.

It may be understood that, because there is noise in the channel for sending the first data between the network device and the terminal device, the network device sends the first data, but the terminal device may not receive the first data, for example, receive third data. Therefore, the terminal device needs to demodulate the third data based on the pilot, to determine the first data sent by the network device. However, for ease of description, in S203, the terminal device receives the first data.

Optionally, before S203, the method further includes: the network device sends first configuration information to the terminal device, where the first configuration information indicates a time domain resource and/or a frequency domain resource of the pilot. In this way, in S203, the network device may send the pilot to the terminal device based on the first configuration information, and the terminal device receives the pilot based on the first configuration information.

Optionally, when the first configuration information indicates the frequency domain resource of the pilot, the first configuration information indicates a subcarrier spacing of the pilot, and the network device may determine, in any one of the following three manners, the subcarrier spacing that is of the pilot and that is indicated by the first configuration information.

Manner 1: The network device determines, based on feedback information corresponding to a first signal, the subcarrier spacing that is of the pilot and that is indicated by the first configuration information.

For example, the network device may send the first signal to the terminal device, the terminal device determines and receives the feedback information corresponding to the first signal, the terminal device sends the feedback information corresponding to the first signal to the network device, and the network device may determine, based on the feedback information corresponding to the first signal, the subcarrier spacing that is of the pilot and that is indicated by the first configuration information. The feedback information corresponding to the first signal indicates signal quality of the received first signal. For example, the feedback information corresponding to the first signal may indicate a signal-to-noise ratio (SNR) of the first signal. For another example, the feedback information corresponding to the first signal may indicate channel state information (CSI) or a channel quality indicator (CQI) of the first signal. For that the terminal device determines the feedback information corresponding to the first signal, refer to a manner in the existing technology. Details are not described again in this embodiment.

Optionally, the first signal may be a sounding signal sent by the network device.

Optionally, that the terminal device sends the feedback information corresponding to the first signal to the network device includes: the terminal device sends the feedback information corresponding to the first signal to the network device by using uplink control information (UCI).

Optionally, when the feedback information corresponding to the first signal indicates the SNR of the first signal, the SNR of the first signal is positively correlated with the subcarrier spacing that is of the pilot and that is indicated by the first configuration information. For example, a higher SNR of the first signal indicates a larger subcarrier spacing that is of the pilot and that is indicated by the first configuration information, and a lower SNR of the first signal indicates a smaller subcarrier spacing that is of the pilot and that is indicated by the first configuration information. In other words, a larger SNR indicates better channel quality of a downlink channel, and channel estimation can be performed by using a small quantity of pilots. Therefore, the subcarrier spacing of the pilot may be large. In this way, a resource occupied by the pilot can be reduced, and a resource occupied for data transmission can be increased, to improve spectral efficiency. A smaller SNR indicates poorer channel quality of a downlink channel, and channel estimation can be performed by using more pilots. Therefore, the subcarrier spacing of the pilot may be small. For example, as shown in Table 1, as the SNR increases, the subcarrier spacing also increases.

Optionally, the network device may store a correspondence between the SNR and the subcarrier spacing of the pilot. After obtaining the SNR of the first signal, the network device determines the subcarrier spacing of the pilot based on the correspondence. For example, the network device stores Table 1. If the SNR that is of the first signal and that is received by the network device is 10 dB, the network device may determine that the subcarrier spacing of the pilot is 150 kHz, and the first configuration information may indicate 150 kHz. If the SNR of the first signal is not an SNR in the correspondence, the network device may determine an SNR that is in the correspondence and that is close to the SNR of the first signal, to determine the subcarrier spacing of the pilot. For example, the network device determines that the SNR of the first signal is 9 dB, and an SNR close to 9 dB in Table 1 is 10 dB. Therefore, the network device determines that the subcarrier spacing of the pilot is 150 kHz.

TABLE 1

| SNR (dB) | Subcarrier spacing of a pilot (kHz) |
|---|---|
| 5 | 30 |
| 10 | 150 |
| 15 | 300 |
| 20 | 400 |
| 25 | 500 |

Manner 2: The network device determines, based on a precision requirement, the subcarrier spacing indicated by the first configuration information.

For example, the precision requirement may be a precision requirement for demodulating the first data by the terminal device. A higher precision requirement for demodulating the first data indicates a smaller subcarrier spacing, and a lower precision requirement for demodulating the first data indicates a larger subcarrier spacing. In other words, if precision of demodulating the first data is higher, a required channel estimation value is more accurate. Therefore, a large quantity of pilots are required to obtain an accurate channel estimation value. In this case, the subcarrier spacing of the pilot is small. If precision of demodulating the first data is lower, the channel estimation value may be inaccurate. Therefore, a less accurate channel estimation value may also be obtained by using a small quantity of pilots. In this case, the subcarrier spacing of the pilot may be large. Refer to Table 2.

Optionally, the network device may store a correspondence between the precision requirement and the subcarrier spacing of the pilot. After obtaining the precision requirement for demodulating the first data, the network device determines the subcarrier spacing of the pilot based on the correspondence. For example, the network device stores Table 2. If the network device determines that the precision requirement for demodulating the first data is 92%, the network device determines that the subcarrier spacing of the pilot is 300 kHz, and the first configuration information may indicate 300 kHz. If the precision requirement for demodulating the first data is not a precision requirement for demodulating the first data in the correspondence, the network device may determine a precision requirement that is in the correspondence and that is close to the precision requirement for demodulating the first data, to determine the subcarrier spacing of the pilot. For example, the network device determines that the precision requirement for demodulating the first data is 91.5%, and a precision requirement close to 91.5% in Table 2 is 92%. Therefore, the network device determines that the subcarrier spacing of the pilot is 300 kHz.

TABLE 2

| Precision requirement | Subcarrier spacing of a pilot (kHz) |
|---|---|
| 90% | 500 |
| 92% | 300 |
| 96% | 150 |
| 97% | 75 |
| 98% | 30 |

Manner 3: The network device determines, based on the SNR and the precision requirement, the subcarrier spacing indicated by the first configuration information.

For example, the precision requirement may be the precision requirement for demodulating the first data by the terminal device. In addition, the network device may send the first signal to the terminal device, the terminal device determines the SNR of the received first signal, the terminal device sends the SNR of the first signal to the network device, and the network device determines, based on the received SNR of the first signal and the precision requirement for demodulating the first data, the subcarrier spacing that is of the pilot and that is indicated by the first configuration information. When the SNR of the first signal is fixed, a lower precision requirement for demodulating the first data indicates a larger subcarrier spacing required, and a higher precision requirement for demodulating the first data indicates a smaller subcarrier spacing required; or when the precision requirement for demodulating the first data is fixed, a larger SNR indicates a larger subcarrier spacing of the pilot, and a smaller SNR indicates a smaller subcarrier spacing of the pilot. As shown in Table 3, when the SNR remains unchanged, a higher precision requirement for demodulating the first data indicates a smaller subcarrier spacing required, and a lower precision requirement for demodulating the first data indicates a larger subcarrier spacing required. When the precision requirement for demodulating the first data is 96%, a larger SNR indicates a larger subcarrier spacing required.

Optionally, the network device may store a correspondence between the precision requirement, the SNR, and the subcarrier spacing of the pilot. After obtaining the precision requirement for demodulating the first data and the SNR of the first signal, the network device determines the subcarrier spacing of the pilot based on the correspondence. For example, the network device stores Table 3. If the network device determines that the precision requirement for demodulating the first data is 92% and the SNR of the first signal is 10 dB, the network device determines that the subcarrier spacing of the pilot is 300 kHz, and the first configuration information may indicate 300 kHz. If the precision requirement for demodulating the first data is not a precision requirement for demodulating the first data in the correspondence, the network device may determine a precision requirement that is in the correspondence and that is close to the precision requirement for demodulating the first data; or if the SNR of the first signal is not an SNR in the correspondence, the network device may determine an SNR that is in the correspondence and that is close to the SNR of the first signal. The network device determines, based on the precision requirement and the SNR that are in the determined correspondence, the subcarrier spacing of the pilot. For example, the network device determines that the precision requirement for demodulating the first data is 91.5%, a precision requirement close to 91.5% in Table 3 is 92%, the SNR of the first signal is 9 dB, and an SNR close to 9 dB in Table 3 is 10 dB. Therefore, the network device determines that the subcarrier spacing of the pilot is 300 kHz.

TABLE 3

| SNR | Precision requirement | Subcarrier spacing of a pilot (kHz) |
|---|---|---|
| 5 | 86% | 500 |
| 5 | 88% | 300 |
| 5 | 93% | 150 |
| 5 | 94% | 75 |
| 5 | 96% | 30 |
| 10 | 90% | 500 |
| 10 | 92% | 300 |
| 10 | 96% | 150 |
| 10 | 97% | 75 |
| 10 | 98% | 30 |
| 15 | 95% | 500 |
| 15 | 96% | 300 |
| 15 | 97% | 150 |
| 15 | 98% | 75 |
| 15 | 99% | 30 |
| 20 | 97% | 500 |
| 20 | 98% | 300 |
| 20 | 99% | 150 |
| 20 | 99.3% | 75 |
| 20 | 99.5% | 30 |
| 25 | 99% | 500 |
| 25 | 99.1% | 300 |
| 25 | 99.2% | 150 |
| 25 | 99.3% | 75 |
| 25 | 99.7% | 30 |

Optionally, in Manner 2 and Manner 3, the network device may determine the precision requirement for demodulating the first data by the terminal device. For example, the network device may determine, based on a data type of the first data sent to the terminal device, the precision requirement for demodulating the first data by the terminal device.

Optionally, a pilot density is less than or equal to a preset density. For example, a pilot density determined in any one of the foregoing three manners is less than or equal to the preset density.

Optionally, a ratio of a resource occupied by the pilot to a total resource is less than or equal to a first preset ratio, and the total resource is a sum of the resource occupied by the pilot and a resource occupied by the first data. Optionally, the first preset ratio is 0.0238 or 0.0476. For example, a ratio that is determined in any one of the foregoing three manners and that is of a resource occupied by the pilot to the total resource is less than or equal to the first preset ratio. Optionally, the resource occupied by the pilot and the total resource may be represented by a resource element (RE). For example, if the pilot occupies S REs, and the total resource is W REs, the ratio of the resource occupied by the pilot to the total resource is S/W.

Optionally, a ratio of the resource occupied by the pilot to the resource occupied by the first data is less than or equal to a second preset ratio. For example, a ratio that is determined in any one of the foregoing three manners and that is of a resource occupied by the pilot to the resource occupied by the first data is less than or equal to the second preset ratio. Optionally, the resource occupied by the pilot and the resource occupied by the first data may be represented by the RE. For example, if the pilot occupies S REs, and the resource occupied by the first data is R REs, the ratio of the resource occupied by the pilot to the resource occupied by the first data is S/R.

It should be noted that, in this embodiment, the network device may alternatively determine the subcarrier spacing of the pilot not depending on any one of the foregoing three manners. The network device may directly configure that the pilot density is less than or equal to the preset density, or the ratio of the resource occupied by the pilot to the total resource is less than or equal to the first preset ratio, or the ratio of the resource occupied by the pilot to the resource occupied by the first data is less than or equal to the second preset ratio.

S204: The terminal device demodulates the first data based on the pilot and the path parameter of each communication path.

Optionally, S204 includes: the terminal device obtains a first channel estimation value by measuring the pilot. The terminal device calibrates the path parameter of each communication path based on the first channel estimation value, to obtain a calibrated path parameter of each communication path. The terminal device demodulates the first data by using the calibrated path parameter of each communication path. In other words, in this embodiment, the terminal device may calibrate the path parameter of each communication path based on the first channel estimation value obtained by using a small quantity of pilots, and demodulate the first data by using the calibrated path parameter of each communication path, to avoid demodulating the first data by using a channel estimation value obtained by using a large quantity of pilots. This can reduce resource overheads occupied by the pilot, and help increase a resource occupied for data transmission, to help improve transmission spectral efficiency.

For example, in LTE, a reference signal in a physical downlink shared channel (PDSCH) is a cell-specific reference signal (CRS), and the terminal device may estimate the PDSCH based on the CRS. In time domain, a slot is used as a unit, and each slot includes 14 symbols. In frequency domain, a resource block (RB) is used as a unit, and one RB includes 12 REs. One slot in time domain and one RB in frequency domain include 168 resource elements (REs) in total, and at least eight REs are required to send the CRS. In this case, a ratio of a quantity of REs occupied by the CRS to a total quantity of REs is 0.0476 (8/168). Therefore, in this embodiment, when the ratio of the resource occupied by the pilot to the total resource in S203 is less than or equal to 0.0476, a quantity of pilots is small compared with that in LTE. Therefore, a quantity of REs occupied by the pilot can be reduced, and a quantity of REs for data transmission can be increased, to help improve transmission spectral efficiency.

For another example, in NR, a reference signal in a PDSCH is a demodulation reference signal (DMRS), and the terminal device may estimate the PDSCH based on the DMRS. In time domain, a slot is used as a unit, and each slot includes 14 symbols. In frequency domain, an RB is used as a unit, and one RB includes 12 REs. One slot in time domain and one RB in frequency domain include 168 REs in total, and at least four REs are required to send the DMRS. In this case, a ratio of a quantity of REs occupied by the DMRS to a total quantity of REs is 0.0238 (4/168). Therefore, in this embodiment, when the ratio of the resource occupied by the pilot to the total resource in S203 is less than or equal to 0.0238, a quantity of pilots is small compared with that in LTE. Therefore, a quantity of REs occupied by the pilot can be reduced, and a quantity of REs for data transmission can be increased, to help improve transmission spectral efficiency.

Optionally, the at least one communication path in S201 is K communication paths. In other words, a path parameter of each of the K communication paths between the network device and the terminal device in S201 is obtained. That the terminal device calibrates the path parameter of each communication path based on the first channel estimation value, to obtain the calibrated path parameter of each communication path includes: determining, under a constraint that differences between path parameters of the K communication paths and calibrated path parameters of the K communication paths are less than a preset value, the calibrated path parameters of the K communication paths, so that the calibrated path parameters of the K communication paths minimize a difference between a second channel estimation value for the pilot and the first channel estimation value. In other words, the terminal device may perform channel estimation on the pilot by using the calibrated path parameters of the K communication paths, to obtain the second channel estimation value; and the terminal device may measure the pilot to obtain the first channel estimation value. The terminal device may search for, under the constraint that the differences between the uncalibrated path parameters of the K communication paths and the calibrated path parameters of the K communication paths are less than the preset value, the calibrated path parameters of the K communication paths, to minimize the difference between the first channel estimation value and the second channel estimation value.

Optionally, the preset value may be specified in a protocol or configured by the network device for the terminal device.

Optionally, there may be one or more preset values, and the path parameter of the communication path includes L parameters. In this case, there may be L preset values, the L parameters are in one-to-one correspondence with the L preset values, any two of the L preset values may be the same or different, and L is a positive integer.

Optionally, the path parameters of the K communication paths may include a delay and an amplitude. Optionally, when the path parameters of the K communication paths include the delay and the amplitude, there may be a preset value corresponding to the delay and a preset value corresponding to the amplitude.

Optionally, the terminal device may determine the calibrated path parameters of the K communication paths according to formula (1) and formula (2):

$${arg min}_{( {A}_{k} , {τ}_{k} )} {‖ [ {\sum }_{k = 1}^{K} {A}_{k} exp ( - j 2 π {f}_{pilot} {τ}_{k} ) ] - H ( {f}_{pilot} ) ‖}^{2} , and \qquad ( 1 )$$

$$s . t . {‖ A - \hat{A} ‖}^{2} < {ε}_{1} {‖ τ - \hat{τ} ‖}^{2} < {ε}_{2} , \qquad ( 2 )$$

where

H(fₚᵢₗₒₜ) in formula (1) is the first channel estimation value,

$${\sum }_{k = 1}^{K} {A}_{k} exp ( - j 2 π {f}_{pilot} {τ}_{k} )$$

in formula (1) is the second channel estimation value,

$${arg min}_{( {A}_{k} , {τ}_{k} )} ( \cdot )$$

is a value for Aₖ and τₖ that enables

$${‖ [ {\sum }_{k = 1}^{K} {A}_{k} exp ( - j 2 π {f}_{pilot} {τ}_{k} ) ] - H ( {f}_{pilot} ) ‖}^{2}$$

to reach a minimum value, A in formula (2)=[A₁, A₂, . . . , A_{K}], Aₖ in formula (1) is a value in A₁, A₂, . . . , A_{K}, A is a vector consisting of calibrated amplitudes of the K communication paths, Â=[Â₁, Â₂, . . . , Â_{K}] and is a vector consisting of amplitudes of the K communication paths, τ=[τ₁, τ₂, . . . , τ_{K}], τₖ in formula (1) is a value in τ₁, τ₂, . . . , τ_{K}, τ is a vector consisting of calibrated delays of the K communication paths, \hat{τ}=[\hat{τ}₁, \hat{τ}₂, . . . , \hat{τ}_{K}] and is a vector consisting of delays of the K communication paths, ε₁ is a preset value corresponding to the amplitude, and ε₂ is a preset value corresponding to the delay. For example, A₁ and τ₁ in A=[A₁, A₂, . . . , A_{K}] and τ=[τ₁, τ₂, . . . , τ_{K}] obtained according to formula (1) and formula (2) are path parameters of a 1^{st} communication path, A₂ and τ₂ are path parameters of a 2^{nd} communication path, . . . , and A_{K} and τ_{K} are path parameters of a K^{th} communication path.

Optionally, that the terminal device may determine the calibrated path parameters of the K communication paths according to formula (1) and formula (2) includes: the terminal device may determine the calibrated path parameters of the K communication paths according to formula (1) and formula (2) by using a maximum likelihood algorithm, a heuristic intelligent search method, or an exhaustion method.

Optionally, the network device sends the first data, and data received by the terminal device may be the third data corresponding to the first data. For example, because there is noise in the channel for sending the first data between the network device and the terminal device, the network device sends the first data, but the terminal device may receive the third data instead of the first data. That the terminal device demodulates the first data by using the calibrated path parameter of each communication path includes: the terminal device determines the second channel estimation value for the pilot based on the calibrated path parameters of the K communication paths, and obtains, through demodulation based on the received third data and the second channel estimation value, the first data sent by the network device.

It should be noted that, for a case in which the path parameter of each of the K communication paths in formula (1) and formula (2) is for single-input single-output of the network device and the terminal device, the network device sends the first data by using one antenna, and the terminal device receives the first data by using one antenna. In a multiple-input multiple-output (multiple-input multiple-output, MIMO) scenario, the network device may send the first data by using a plurality of antennas, and the terminal device may receive the first data by using a plurality of antennas. For example, when the network device sends the first data by using M antennas, and the terminal device may receive the first data by using N antennas, formula (1) may be changed to formula (3), and formula (2) may be changed to formula (4):

$${arg min}_{( {A}_{k} , {τ}_{k} )} {‖ [ {\sum }_{k = 1}^{K} {A}_{k}^{m , n} exp ( - j 2 π {f}_{pilot} {τ}_{k}^{m , n} ) ] - {H}^{m , n} ( {f}_{pilot} ) ‖}^{2} , and \qquad ( 3 )$$

$$s . t . {‖ {A}^{m , n} - {\hat{A}}^{m , n} ‖}^{2} < {ε}_{1}^{m , n} {‖ {τ}^{m , n} - {\hat{τ}}^{m , n} ‖}^{2} < {ε}_{2}^{m , n} , \qquad ( 4 )$$

where

Aₖ^{m,n} in formula (3) is an amplitude of a pilot that is sent by an m^{th} antenna in the M antennas of the network device and that is received by an n^{th} antenna in the N antennas of the terminal device, m=[1, 2, . . . , M], n=[1, 2, . . . , N], τₖ^{m,n} is a delay of the pilot that is sent by the m^{th} antenna in the M antennas of the network device and that is received by the n^{th} antenna in the N antennas of the terminal device, H^{m,n}(fₚᵢₗₒₜ) in formula (3) is a first channel estimation value for the pilot that is sent by the m^{th} antenna of the network device and that is received by the n^{th} antenna of the terminal device,

$${\sum }_{k = 1}^{K} {A}_{k}^{m , n} exp ( - j 2 π {f}_{pilot} {τ}_{k}^{m , n} )$$

in formula (3) is a second channel estimation value for the pilot that is sent by the m^{th} antenna of the network device and that is received by the n^{th} antenna of the terminal device,

$${arg min}_{( {A}_{k} , {τ}_{k} )} ( \cdot )$$

is a value for Aₖ and τₖ that enables

$${‖ [ {\sum }_{k = 1}^{K} {A}_{k}^{m , n} exp ( - j 2 π {f}_{pilot} {τ}_{k}^{m , n} ) ] - {H}^{m , n} ( {f}_{pilot} ) ‖}^{2}$$

to reach a minimum value, A^{m,n} in formula (4)=[A₁^{m,n}, A₂^{m,n}, . . . , A_{K}^{m,n}], Aₖ^{m,n} in formula (3) is a value in A₁^{m,n}, A₂^{m,n}, . . . , A_{K}^{m,n}, A^{m,n} is a vector consisting of calibrated amplitudes of the K communication paths, Â^{m,n}=[Â₁^{m,n}, Â₂^{m,n}, . . . , Â_{K}^{m,n}] and is a vector consisting of amplitudes of the K communication paths, τ^{m,n}=[τ₁^{m,n}, τ₂^{m,n}, . . . , τ_{K}^{m,n}], τₖ^{m,n} in formula (3) is a value in τ₁^{m,n}, τ₂^{m,n}, . . . , τ_{K}^{m,n}, τ^{m,n} is a vector consisting of calibrated delays of the K communication paths, \hat{τ}^{m,n}=[\hat{τ}₁^{m,n}, \hat{τ}₂^{m,n}, . . . , \hat{τ}_{K}^{m,n}] and is a vector consisting of delays of the K communication paths, ε₁^{m,n} is a preset value corresponding to the amplitude of the pilot that is sent by the m^{th} antenna of the network device and that is received by the n^{th} antenna of the terminal device, and ε₂ is a preset value corresponding to the delay of the pilot that is sent by the m^{th} antenna of the network device and that is received by the n^{th} antenna of the terminal device.

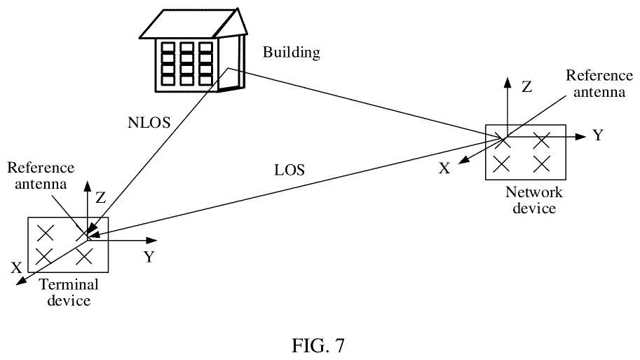

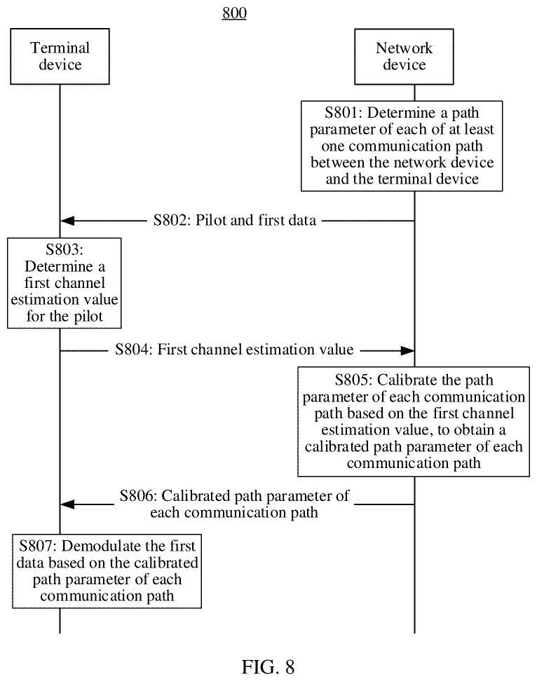

In some embodiments, when the network device has the M antennas to send the first data, and the terminal device may receive the first data by using the N antennas, there are M*N antenna combinations in total. One antenna combination is a combination of one antenna of the network device and one antenna of the terminal device. For example, FIG. 7 shows a scenario in which the first data is sent by using one antenna combination. Each antenna combination corresponds to a same quantity of communication paths. In other words, even if different antenna combinations are used to send the first data, because a transmit end is the network device, a receive end is the terminal device, and reflectors between the network device and the terminal device are the same, quantities of communication paths corresponding to all antenna combinations are the same. For example, a 1^{st} antenna of the network device and a 1^{st} antenna of the terminal device correspond to one NLOS, and a 2^{nd} antenna of the network device and the 1^{st} antenna of the terminal device correspond to one NLOS. In a possible implementation, the network device may sequentially determine a path parameter of at least one communication path corresponding to each of the M*N antenna combinations, and then calibrate the path parameter corresponding to each antenna combination. Alternatively, in another possible implementation, the network device may determine a path parameter of an antenna path of another antenna combination based on a path parameter of a communication path of one antenna combination, and calibrate a path parameter corresponding to each antenna combination.

The following describes an example in which the network device determines a path parameter of an antenna path of another antenna combination based on a path parameter of a communication path of one antenna combination. The network device may determine, according to S201, that path parameters of K communication paths between the 1^{st} antenna of the network device and the antenna the 1 st of terminal device are {τₖ^{1,1},Aₖ^{1,1},AODₖ^{1,1},ZODₖ^{1,1},AOAₖ^{1,1},ZOAₖ^{1,1}|k∈[1,K]}, where a superscript (1,1) represents the 1^{st} antenna of the network device and the 1^{st} antenna of the terminal device. Therefore, path parameters of K communication paths between the m^{th} antenna of the network device and the n^{th} antenna of the terminal device are {τₖ^{m,n},Aₖ^{m,n},AODₖ^{m,n},ZODₖ^{m,n},AOAₖ^{m,n},ZOAₖ^{m,n}|k∈[1,K]}. {τₖ^{m,n},Aₖ^{m,n},AODₖ^{m,n},ZODₖ^{m,n},AOAₖ^{m,n},ZOAₖ^{m,n}|k∈[1,K]} may be obtained by using {τₖ^{1,1},Aₖ^{1,1},AODₖ^{1,1},ZODₖ^{1,1},AOAₖ^{1,1},ZOAₖ^{1,1}|k∈[1,K]}, which is as follows:

$${τ}_{k}^{m , n} = {τ}_{k}^{1 , 1} + Δ {τ}_{k}^{tx , m} + Δ {τ}_{k}^{rx , n} , \qquad ( 5 )$$

$$Δ {τ}_{k}^{tx , m} = [ ( {x}_{tx}^{m} - {x}_{tx}^{1} ) sin ( {ZOD}_{k}^{1 , 1} ) cos ( {AOD}_{k k}^{1 , 1} ) + ( {y}_{tx}^{m} - {y}_{tx}^{1} ) sin ( {ZOD}_{k}^{1 , 1} ) sin ( {AOD}_{k}^{1 , 1} ) + ( {z}_{tx}^{m} - {z}_{tx}^{1} ) cos ( {ZOD}_{k}^{1 , 1} ) ] / c , \qquad ( 6 )$$

$$Δ {τ}_{k}^{rx , m} = [ ( {x}_{r x}^{m} - {x}_{r x}^{1} ) sin ( {ZOA}_{k}^{1 , 1} ) cos ( {AOA}_{k}^{1 , 1} ) + ( {y}_{r x}^{m} - {y}_{r x}^{1} ) sin ( {ZOA}_{k}^{1 , 1} ) sin ( {AOA}_{k}^{1 , 1} ) + ( {z}_{r x}^{m} - {z}_{r x}^{1} ) cos ( Z O {A}_{k}^{1 , 1} ) ] / c , \qquad ( 7 )$$

$${A}_{k}^{m , n} = {A}_{k}^{1 , 1} , \qquad ( 8 )$$

$$AO {D}_{k}^{m , n} = A O {D}_{k}^{1 , 1} , \qquad ( 9 )$$

$${ZOD}_{k}^{m , n} = {ZOD}_{k}^{1 , 1} , \qquad ( 10 )$$

$${AOA}_{k}^{m , n} = {AOA}_{k}^{1 , 1} , and \qquad ( 11 )$$

$${ZOA}_{k}^{m , n} = {ZOA}_{k}^{1 , 1} , \qquad ( 12 )$$

where

in formula (5), Δτₖ^{tx,m} is a delay difference between the m^{th} antenna and the 1^{st} antenna that are of the network device, and Δτₖ^{rx,n} is a delay difference between the n^{th} antenna and the 1^{st} antenna that are of the terminal device, that is, the delay of the pilot that is sent by the m^{th} antenna of the network device and that is received by the n^{th} antenna of the terminal device may be obtained based on a sum of a delay τₖ^{1,1} that is of the 1^{st} antenna of the network device and that is of the 1^{st} antenna of the terminal device, the delay difference Δτₖ^{tx,m} between the m^{th} antenna and the 1^{st} antenna that are of the network device, and the delay difference between the n^{th} antenna and the 1^{st} antenna that are of the terminal device; in formula (6), for calculating Δτₖ^{tx,m}, xₜₓ^{tx,m} is a coordinate of the m^{th} antenna of the network device on an X-axis, xₜₓ¹ is a coordinate of the 1^{st} antenna of the network device on the X-axis, yₜₓ^{m} is a coordinate of the m^{th} antenna of the network device on a Y-axis, yₜₓ¹ is a coordinate of the 1^{st} antenna of the network device on the Y-axis, zₜₓ^{m} is a coordinate of the m^{th} antenna of the network device on a Z-axis, zₜₓ¹ is a coordinate of the 1^{st} antenna of the network device on the Z-axis, and in formula (6), xₜₓ^{m}−xₜₓ¹, yₜₓ^{m}−yₜₓ¹, and zₜₓ^{m}−zₜₓ¹ may be obtained based on a physical relationship between the m^{th} antenna and the 1^{st} antenna that are of the network device; in formula (7), for calculating Δτₖ^{tx,n}, xₜₓⁿ is a coordinate of the n^{th} antenna of the terminal device on the X-axis, xᵣₓ¹ is a coordinate of the 1^{st} antenna of the terminal device on the X-axis, yₜₓⁿ is a coordinate of the n^{th} antenna of the terminal device on the Y-axis, yᵣₓ¹ is a coordinate of the 1^{st} antenna of the terminal device on the Y-axis, zₜₓⁿ is a coordinate of the n^{th} antenna of the terminal device on the Z-axis, zᵣₓ¹ is a coordinate of the 1^{st} antenna of the terminal device on the Z-axis, and in formula (7), xᵣₓⁿ−xᵣₓ¹, yᵣₓⁿ−yᵣₓ¹, and zᵣₓⁿ−zᵣₓ¹ may be obtained based on a physical relationship between the n^{th} antenna and the 1^{st} antenna that are of the terminal device, in other words, τₖ^{m,n} is determined based on τₖ^{1,1}, AODₖ^{1,1}, ZODₖ^{1,1}, AOAₖ^{1,1}, and ZOAₖ^{1,1}; in formula (8), an amplitude Aₖ^{m,n} of a k^{th} communication path between the m^{th} antenna of the network device and the n^{th} antenna of the terminal device is equal to Aₖ^{1,1}; in formula (9), AODₖ^{m,n} of the k^{th} communication path between the m^{th} antenna of the network device and the n^{th} antenna of the terminal device is equal to AODₖ^{1,1}; in formula (10), ZODₖ^{m,n} of the k^{th} communication path between the m^{th} antenna of the network device and the n^{th} antenna of the terminal device is equal to ZODₖ^{1,1}; in formula (11), AOAₖ^{m,n} of the k^{th} communication path between the m^{th} antenna of the network device and the n^{th} antenna of the terminal device is equal to AOAₖ^{1,1}; and in formula (12), ZOAₖ^{m,n} of the k^{th} communication path between the m^{th} antenna of the network device and the n^{th} antenna of the terminal device is equal to ZOAₖ^{1,1}.

In the foregoing method embodiment, in a process of sending the first data to the terminal device, the network device may also send a small quantity of pilots. The terminal device may calibrate the path parameter of each of the at least one communication path between the network device and the terminal device based on the first channel estimation value obtained by using the small quantity of pilots, to obtain the calibrated path parameter of each communication path. The calibrated path parameter of each communication path may be used to demodulate the first data. In comparison with the existing technology in which only a large quantity of pilots are used to estimate the first data and then the first data is demodulated based on an estimation value, resource overheads occupied by the pilot can be reduced, to help improve transmission spectral efficiency. For example, when a center frequency is 3.5 GHz, the subcarrier spacing is 15 kHz, the SNR is 25 dB, and a bandwidth is 100 MHZ, Table 4 is a result of a method for demodulating the first data based on the calibrated path parameter of each communication path in this embodiment, and Table 5 is a result of a method for estimating the first data based only on a large quantity of pilots and then demodulating the first data in the existing technology. It can be understood from Table 4 and Table 5 that, in the method in this embodiment, high precision of demodulating the first data can be obtained by using fewer pilots, while in the existing technology, even if more pilots are used, precision of demodulating the first data is still very low.

TABLE 4

| Subcarrier spacing of a pilot | 300 | 150 | 75 | 30 |
|---|---|---|---|---|
| Precision | 99.1% | 99.2% | 99.3% | 99.7% |

TABLE 5

| Subcarrier spacing of a pilot | 30 | 10 | 5 | 3 |
|---|---|---|---|---|
| Precision | 67.7% | 94.0% | 95.2% | 95.3% |

In the method for demodulating the first data based on the calibrated path parameter of each communication path in this embodiment, a small quantity of pilots are used. In some embodiments, the feedback information corresponding to the first signal may indicate the SNR of the first signal. When the feedback information corresponding to the first signal indicates the SNR of the first signal, the network device may determine a modulation and coding scheme (MCS) index based on the SNR of the first signal, or the network device may alternatively determine the MCS index based on the precision requirement for demodulating the first data. This can avoid signaling overheads caused in the existing technology that the terminal device further needs to feed back CSI or a CQI and that the network device needs to determine the modulation and coding scheme (MCS) index based on the CSI or the CQI. In this embodiment, a delay can be reduced.

In the method 200 in FIG. 2, the network device sends the path parameter of each of the at least one communication path between the network device and the terminal device to the terminal device, and the network device may send the first data and the pilot to the terminal device. The terminal device calibrates the path parameter of each communication path based on the first channel estimation value for the pilot, and demodulates the first data by using the calibrated path parameter of each communication path. In some embodiments, the network device may also calibrate the path parameter of each communication path, and send the calibrated path parameter of each communication path to the terminal device. The terminal device may demodulate the first data based on the calibrated path parameter of each path. The following provides descriptions with reference to a data transmission method 800 in FIG. 8. As shown in FIG. 8, the method 800 includes the following steps.

S801 is the same as S201.

S802 is the same as S203.

S803: The terminal device determines a first channel estimation value for the pilot.

Optionally, for descriptions of the terminal device determining the first channel estimation value for the pilot, refer to the descriptions in the method 200.

S804: The terminal device sends the first channel estimation value to the network device, and the network device receives the first channel estimation value.

Optionally, S804 includes: the terminal device sends UCI to the network device, where the UCI includes the first channel estimation value.

S805: The network device calibrates the path parameter of each communication path based on the first channel estimation value, to obtain a calibrated path parameter of each communication path.

The method for calibrating, by the network device, the path parameter of each communication path in S805 is similar to the calibration method in S204. To avoid repetition, details are not described again.

S806: The network device sends the calibrated path parameter of each communication path to the terminal device, and the terminal device receives the calibrated path parameter of each communication path from the network device.

Optionally, the network device may send the calibrated path parameter of each communication path to the terminal device by using RRC signaling or DCI.

S807: The terminal device demodulates the first data based on the calibrated path parameter of each communication path.

For descriptions of the terminal device demodulating the first data based on the calibrated path parameter of each communication path in S807, refer to the descriptions in the method 200. To avoid repetition, details are not described again.

It should be noted that S802 in which the network device sends the first data may precede S807. However, a sequence between the network device and any step in S803 to S806 is not limited.

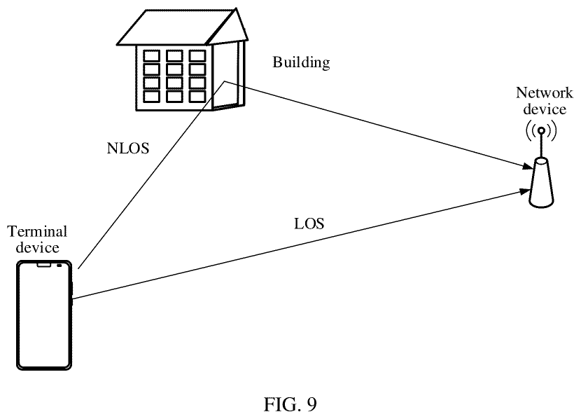

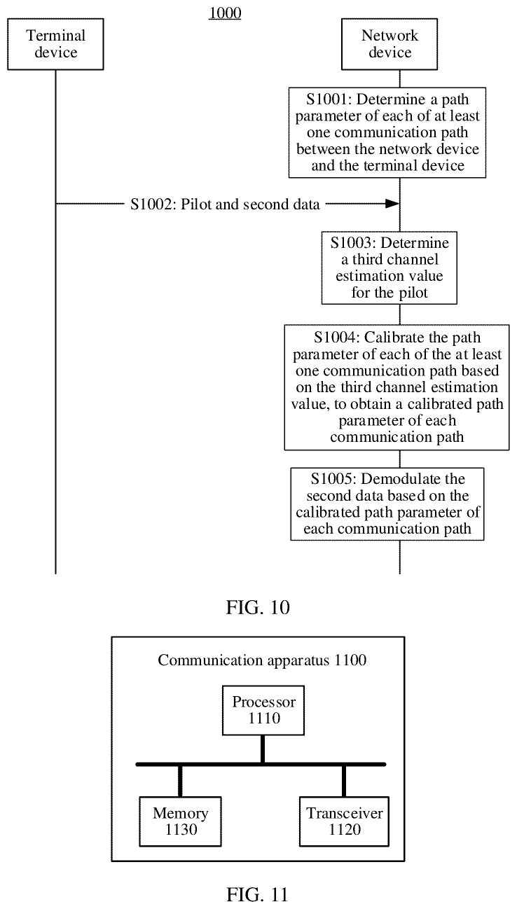

The embodiments in FIG. 2 and FIG. 8 are described in terms of downlink data, that is, the network device sends the first data to the terminal device. Embodiments may also be applied to an uplink scenario, that is, the terminal device may also send second data to the network device. In an uplink scenario shown in FIG. 9, the terminal device may send the second data to the network device through one LOS and one NLOS. In this embodiment, at least one communication path between the network device and the terminal device may be an NLOS. The network device may calibrate a path parameter of each of the at least one communication path between the network device and the terminal device, and demodulate the uplink second data by using the calibrated path parameter of each communication path. The following describes an uplink scenario with reference to a data transmission method 1000 in FIG. 10. As shown in FIG. 10, the method 1000 includes the following steps.

S1001 is the same as S201.

S1002: The terminal device sends a pilot and second data to the network device, and the network device receives the pilot and the second data.

Before S1002, the method further includes: the terminal device sends second configuration information to the network device, where the second configuration information indicates a time-frequency resource location of the pilot in S1002. In this way, in S1002, the terminal device may send the pilot to the network device based on the second configuration information, and the network device may receive the pilot based on the second configuration information.

Optionally, the second configuration information indicates a subcarrier spacing of the pilot in S1002. For a manner in which the terminal device determines the subcarrier spacing that is of the pilot and that is indicated by the second configuration information, refer to any one of the three manners in which the network device determines the subcarrier spacing that is of the pilot and that is indicated by the first configuration information in S203.

Optionally, similar to the method 200, a pilot density in S1002 is less than or equal to a preset density.

Optionally, similar to the method 200, a ratio of a resource of the pilot to a total resource in S1002 is less than or equal to a third preset ratio, and the total resource is a sum of the resource occupied by the pilot and a resource occupied by the second data.

Optionally, similar to the method 200, a ratio of the resource occupied by the pilot to the resource occupied by the second data is less than or equal to a fourth preset ratio.

Optionally, in S1002, a sequence in which the terminal device sends the pilot and the first data is not limited.

S1003: The network device obtains a third channel estimation value by measuring the pilot.

S1004: The network device calibrates the path parameter of each of the at least one communication path based on the third channel estimation value, to obtain a calibrated path parameter of each communication path.

It should be noted that the method for calibrating the path parameter of each communication path by the network device in S1004 is similar to the method for calibrating the path parameter of each communication path by the terminal device in the method 200. To avoid repetition, details are not described again. Different from the method 200, in the method 1000, a sending device is the terminal device, and a receiving device is the network device. For example, the TX in FIG. 5 is the terminal device, and the RX in FIG. 6 is the network device.

S1005: The network device demodulates the second data based on the calibrated path parameter of each communication path.

It should be noted that, in the method 200, the method 800, and the method 1000, data is demodulated based on the calibrated path parameter of each communication path. In some embodiments, the uncalibrated path parameter of each communication path may also be used to demodulate the data.

It should also be noted that the network device in the foregoing method embodiment may be replaced with the terminal device, that is, the foregoing method embodiment is also applicable to a D2D scenario.

The foregoing describes the method embodiments provided in the embodiments, and the following describes apparatus embodiments that are provided. It should be understood that descriptions of apparatus embodiments correspond to the descriptions of the method embodiments. Therefore, for content that is not described in detail, refer to the method embodiments. For brevity, details are not described herein again.

FIG. 11 shows a communication apparatus 1100 according to an embodiment. The communication apparatus 1100 includes a processor 1110 and a transceiver 1120. The processor 1110 and the transceiver 1120 communicate with each other through an internal connection path, and the processor 1110 is configured to execute instructions, to control the transceiver 1120 to send a signal and/or receive a signal.

Optionally, the communication apparatus 1100 may further include a memory 1130. The memory 1130 communicates with the processor 1110 and the transceiver 1120 through internal connection paths. The memory 1130 is configured to store instructions, and the processor 1110 may execute the instructions stored in the memory 1130. In a possible implementation, the communication apparatus 1100 is configured to implement procedures and steps corresponding to the first device or the terminal device in the foregoing method embodiments. In another possible implementation, the communication apparatus 1100 is configured to implement procedures and steps corresponding to the second device or the network device in the foregoing method embodiments.

It should be understood that the communication apparatus 1100 may be the first device, the terminal device, the network device, or the second device in the foregoing embodiments, or may be a chip or a chip system. Correspondingly, the transceiver 1120 may be a transceiver circuit of the chip. This is not limited herein. For example, the communication apparatus 1100 may be configured to perform steps and/or procedures corresponding to the first device, the terminal device, the network device, or the second device in the foregoing method embodiments. Optionally, the memory 1130 may include a read-only memory and a random access memory, and provide the instructions and data for the processor. A part of the memory may further include a non-volatile random access memory. For example, the memory may further store information of a device type. The processor 1110 may be configured to execute the instructions stored in the memory. In addition, when the processor 1110 executes the instructions stored in the memory, the processor 1110 is configured to perform the steps and/or procedures corresponding to the first device, the terminal device, the network device, or the second device in the foregoing method embodiments.

In an implementation process, steps in the foregoing methods can be completed by using a hardware integrated logic circuit in the processor, or by using instructions in a form of software. The steps of the method with reference to embodiments may be directly performed by a hardware processor, or may be performed by using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor. To avoid repetition, details are not described herein again.

It should be noted that, the processor in embodiments may be an integrated circuit chip, and has a signal processing capability. In an implementation process, the steps in the foregoing method embodiments may be completed by using a hardware integrated logic circuit in the processor or instructions in a form of software. The processor may be a general-purpose processor, a digital signal processor (DSP), an application-specific integrated circuit (ASIC), a field programmable gate array (FPGA) or another programmable logic device, a discrete gate or transistor logic device, or a discrete hardware component. The processor may implement or perform the methods, steps, and logical block diagrams that are in embodiments. The general-purpose processor may be a microprocessor, or the processor may be any conventional processor or the like. The steps in the methods with reference to embodiments may be directly performed and completed by a hardware decoding processor, or may be performed and completed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor.

It may be understood that the memory in embodiments may be a volatile memory or a non-volatile memory, or may include a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), and is used as an external cache. Through example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM). It should be noted that the memory in the system and methods described includes, but is not limited to, these and any memory of another proper type.

According to the method provided in embodiments, the embodiments further provide a computer program product. The computer program product includes computer program code. When the computer program code is run on a computer, the computer is enabled to perform the steps or procedures performed by the first device, the terminal device, the network device, or the second device in the foregoing method embodiments.

According to the method provided in embodiments, this application further provides a non-transitory computer-readable storage medium. The non-transitory computer-readable storage medium stores program code. When the program code is run on a computer, the computer is enabled to perform the steps or procedures performed by the first device, the terminal device, the network device, or the second device in the foregoing method embodiments.

According to the method provided in embodiments, the embodiments further provide a communication system. The communication system includes one or more terminal devices and one or more network devices, or includes one or more first devices and one or more second devices.

Descriptions of the foregoing apparatus embodiments completely correspond to descriptions of the foregoing method embodiments. A corresponding module or unit performs a corresponding step. For example, a communication unit (a transceiver) performs a receiving step or a sending step in the method embodiments, and a processing unit (a processor) may perform a step other than the sending step or the receiving step. A function of a specific unit may be based on a corresponding method embodiment. There may be one or more processors.

In the embodiments, “indication” may include a direct indication and an indirect indication, or may include an explicit indication and an implicit indication. Information indicated by specific information is referred to as to-be-indicated information. In a specific implementation process, the to-be-indicated information may be indicated in many manners. By way of example but not limitation, the to-be-indicated information may be directly indicated. For example, the to-be-indicated information or an index of the to-be-indicated information is indicated. Alternatively, the to-be-indicated information may be indirectly indicated by indicating other information, and there is an association relationship between the other information and the to-be-indicated information. Alternatively, only a part of the to-be-indicated information may be indicated, and the other part of the to-be-indicated information is known or pre-agreed on. For example, specific information may alternatively be indicated by using an arrangement sequence of a plurality of pieces of information that is pre-agreed on (for example, stipulated in a protocol), to reduce indication overheads to some extent.

In embodiments, the terms and the English abbreviations are all examples given for ease of description, and should not constitute any limitation on the embodiments. The embodiments do not exclude a possibility of defining another term that can implement a same or similar function in an existing or future protocol.

It should be understood that “a plurality of” in embodiments represents “two or more”.

It should be understood that “and/or” describes an association relationship between associated objects, and represents that three relationships may exist. For example, A and/or B may represent the following cases: A exists alone, both A and B exist, and B exists alone, where A and B may be singular or plural. The character “/” usually indicates an “or” relationship between the associated objects.

A person of ordinary skill in the art may be aware that, in combination with illustrative logical blocks and steps described in embodiments may be implemented by electronic hardware or a combination of computer software and electronic hardware. Whether the functions are performed by hardware or software depends on particular applications and design constraint conditions of the solutions. A person skilled in the art may use different methods to implement the described functions for each particular application, but it should not be considered that the implementation goes beyond the scope of the embodiments.

It may be clearly understood by a person skilled in the art that, for the purpose of convenient and brief description, for a detailed working process of the foregoing system, apparatuses, and units, refer to a corresponding process in the foregoing method embodiments, and details are not described herein again.

In the several embodiments provided in the embodiments, it should be understood that the system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings, direct couplings, or communication connections may be implemented through some interfaces. The indirect couplings or communication connections between the apparatuses or units may be implemented in electronic, mechanical, or another form.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions of embodiments.

In addition, functional units in embodiments of the embodiments may be integrated into one processing unit, or each of the units may exist alone physically, or two or more units are integrated into one unit.

In the foregoing embodiments, all or some of the functions of the functional units may be implemented by using software, hardware, firmware, or any combination thereof. When the software is used to implement embodiments, all or some of embodiments may be implemented in a form of a computer program product. The computer program product includes one or more computer instructions (programs). When the computer program instructions (programs) are loaded and executed on a computer, all or some of the procedures or functions according to embodiments are generated. The computer may be a general-purpose computer, a dedicated computer, a computer network, or another programmable apparatus. The computer instructions may be stored in a non-transitory computer-readable storage medium or may be transmitted from a non-transitory computer-readable storage medium to another non-transitory computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The non-transitory computer-readable storage medium may be any usable medium accessible by the computer, or a data storage device, for example, a server or a data center, including one or more usable media. The usable medium may be a magnetic medium (for example, a floppy disk, a hard disk, or a magnetic tape), an optical medium (for example, a DVD), a semiconductor medium (for example, a solid-state drive (solid-state disk, SSD)), or the like.

When the function is implemented in a form of a software functional unit and sold or used as an independent product, the function may be stored in a non-transitory computer-readable storage medium. Based on such an understanding, the solutions of the embodiments essentially, or the part contributing to the existing technology, or some of the solutions may be implemented in a form of a software product. The computer software product is stored in a storage medium, and includes several instructions for instructing a computer device (which may be a personal computer, a server, a network device, or the like) to perform all or some of the steps of the methods described in embodiments. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of the embodiments, but are not intended to limit their scope. Any variation or replacement readily figured out by a person skilled in the art shall fall within the scope of the embodiments.

1. A method comprising:
obtaining a path parameter of each of at least one communication path between a first device and a second device;
receiving a pilot and first data; and
demodulating the first data based on the pilot and the path parameter of each communication path.

2. The method according to claim 1, wherein demodulating the first data based on the pilot and the path parameter of each communication path further comprises:
obtaining a first channel estimation value by measuring the pilot;
calibrating the path parameter of each communication path based on the first channel estimation value, to obtain a calibrated path parameter of each communication path; and
demodulating the first data based on the calibrated path parameter of each communication path.

3. The method according to claim 2, wherein the at least one communication path is K communication paths, and calibrating the path parameter of each communication path based on the first channel estimation value, to obtain the calibrated path parameter of each communication path further comprises:
determining, under a constraint that differences between path parameters of the K communication paths and calibrated path parameters of the K communication paths are less than a preset value, the calibrated path parameters of the K communication paths, so that the calibrated path parameters of the K communication paths minimize a difference between a second channel estimation value for the pilot and the first channel estimation value.

4. The method according to claim 1, wherein before obtaining the path parameter of each communication path between the first device and the second device, the method further comprises:
sending location information of the first device to the second device, wherein the path parameter of each of the at least one communication path corresponds to the location information of the first device.

5. The method according to claim 1, wherein a ratio of a resource occupied by the pilot to a total resource is less than or equal to a first preset value, and the total resource is a sum of the resource occupied by the pilot and a resource occupied by the first data.

6. The method according to claim 1, further comprising:
receiving first configuration information, wherein the first configuration information indicates a frequency domain resource of the pilot; and
receiving the pilot further comprises:
receiving the pilot based on the first configuration information.

7. A method comprising:
determining a path parameter of each of at least one communication path between a first device and a second device;
sending the path parameter of each of the at least one communication path; and
sending a pilot and first data, wherein the pilot and the path parameter of each communication path are used to demodulate the first data.

8. The method according to claim 7, wherein determining the path parameter of each communication path between the first device and the second device further comprises:
receiving location information of the first device; and
determining the path parameter of each of the at least one communication path based on the location information of the first device and a map.

9. The method according to claim 7, wherein a ratio of a resource occupied by the pilot to a total resource is less than or equal to a first preset value, and the total resource is a sum of the resource occupied by the pilot and a resource occupied by the first data.

10. The method according to claim 7, further comprising:
sending first configuration information, wherein the first configuration information indicates a frequency domain resource of the pilot; and
sending the pilot further comprises:
sending the pilot based on the first configuration information.

11. An apparatus comprising a processor coupled to a memory storing instructions, which when executed by the processor, cause the apparatus to:
obtain a path parameter of each of at least one communication path between the first device and a second device;
receive a pilot and first data; and
demodulate the first data based on the pilot and the path parameter of each communication path.

12. The apparatus according to claim 11, wherein the instructions are further executed by the processor to cause the apparatus to:
obtain a first channel estimation value by measuring the pilot;
calibrate the path parameter of each communication path based on the first channel estimation value, to obtain a calibrated path parameter of each communication path; and
demodulate the first data based on the calibrated path parameter of each communication path.

13. The apparatus according to claim 12, wherein the at least one communication path is K communication paths, and the instructions are further executed by the processor to cause the apparatus to:
determine, under a constraint that differences between path parameters of the K communication paths and calibrated path parameters of the K communication paths are less than a preset value, the calibrated path parameters of the K communication paths, so that the calibrated path parameters of the K communication paths minimize a difference between a second channel estimation value for the pilot and the first channel estimation value.

14. The apparatus according to claim 11, wherein the instructions are further executed by the processor to cause the apparatus to:
send, before the obtaining a path parameter of each of at least one communication path between the first device and a second device, location information of the first device to the second device, wherein the path parameter of each of the at least one communication path corresponds to the location information of the first device.

15. The apparatus according to claim 11, wherein a ratio of a resource occupied by the pilot to a total resource is less than or equal to a first preset value, and the total resource is a sum of the resource occupied by the pilot and a resource occupied by the first data.

16. The apparatus according to claim 11, wherein the instructions are further executed by the processor to, further cause the apparatus to:
receive first configuration information, wherein the first configuration information indicates a frequency domain resource of the pilot; and
receiving the pilot further comprises:
receiving the pilot based on the first configuration information.

17. An apparatus, comprising a processor coupled to a memory storing instructions, which when executed by the processor, cause the apparatus to:
determine a path parameter of each of at least one communication path between a first device and the second device;
send the path parameter of each of the at least one communication path; and
send a pilot and first data, wherein the pilot and the path parameter of each communication path are used to demodulate the first data.

18. The apparatus according to claim 17, wherein when the instructions are further executed by the processor to cause the apparatus to:
receive location information of the first device; and
determine the path parameter of each of the at least one communication path based on the location information of the first device and a map.

19. The apparatus according to claim 17, wherein a ratio of a resource occupied by the pilot to a total resource is less than or equal to a first preset value, and the total resource is a sum of the resource occupied by the pilot and a resource occupied by the first data.

20. The apparatus according to claim 17, wherein the instructions are further executed by the processor to cause the apparatus to:
send first configuration information, wherein the first configuration information indicates a frequency domain resource of the pilot; and
sending the pilot further comprises:
sending the pilot based on the first configuration information.
